(19) United States
(12) Patent Application Publication
(10) Pub. No.: US 2009/0234774 A1
(43) Pub. Date: Sep. 17, 2009

(54) SYSTEM FOR BEHAVIORAL ADVISORY SERVICES

(75) Inventors: Spenser Segal, Plymouth, MN (US); Douglas A. Lennick, Edina, MN (US)

Correspondence Address: SCHWEGMAN, LUNDBERG & WOESSNER, P.A., P.O. BOX 2938, MINNEAPOLIS, MN, 55402, US

(73) Assignee: ActiFi, Inc., Plymouth, MN (US)

(21) Appl. No.: 12/116,844

(22) Filed: May 7, 2008

Related U.S. Application Data
(60) Provisional application No. 61/036,811, filed on Mar. 14, 2008.

(51) Int. Cl. G06Q 40/00

(52) U.S. Cl. 705/36 R

(57) ABSTRACT

A neuroeconomics-based financial advisory service system is disclosed. The system has a database used to collect relevant neuroeconomics information such as detailed information about the customer including factors that describe the psychology of the customer. The information about the customer will be used to create a behaviour advisory plan for the customer. Detailed information about each financial service advisors is also collected to create a behaviour advisory profile for each financial services advisor. A recognize process is then used to recognize freeze moments when current decisions may need to be re-considered. A ‘reflect process’ may then be invoked. The reflect process creates a summary of the cognitive, emotional, and physical impacts on investment decision making. Finally, a ‘reframe process’ and ‘respond process’ may then be invoked. The reframe process considers the customer information and the current situation in order to generate talking points and scripts that ma be used by financial service advisors when communicating with a particular customer. The respond process helps the financial service advisor create an action plan after communicating with the customer using the information generated by the reframe process.

### CROSS-REFERENCE TO RELATED PATENT DOCUMENTS

This patent application claims the benefit of priority, under 35 U.S.C. Section 119(e), to Segal et al. U.S. Provisional Patent Application Ser. No. 61/036,811, entitled “SYSTEM FOR BEHAVIORAL ADVISORY SERVICES,” filed on Mar. 14, 2008 (Attorney Docket No. 1944.002PRV).

### TECHNICAL FIELD

The inventive subject matter relates generally to a system for process automation and more particularly to a system for electronic automation, integration and systematization of behavioral advisory principles (including but not limited to neuroeconomics) into financial advisory services.

### BACKGROUND

There is also now widespread and almost universal use of computers, software and electronic communications and data exchange in the financial advisory services industry. These tools have increased productivity by a large measure over time by simplifying and automating many tasks that required tedious and time consuming manual planning and preparation.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 illustrates a diagrammatic representation of machine in the example form of a computer system within which a set of instructions, for causing the machine to perform any one or more of the methodologies discussed herein, may be executed.

FIG. 2A illustrates a high-level block diagram the process used to create a Behavioral Advisory Profile for an individual customer advisor.

FIG. 2B illustrates the process used to create a Behavioral Advisory Profile for an individual client of an advisor.

FIG. 3A illustrates a flow diagram of how an advisor recognizes the need to examine a situation for the behavioral advisory impact.

FIG. 3B process used to create a set of “Freeze Moment Alerts” that will be generated systematically.

FIG. 3C illustrates a flow diagram that illustrates how trigger events are handled when trigger events occur.

FIG. 4 illustrates a high-level flow diagram of the reflect process used to generate a set of factors that may affect decision making.

FIG. 5 illustrates a high-level flow diagram of the refraining process that considers the set of factors that may affect decision making in order to select a suitable set of talking points.

FIG. 6 illustrates a high-level flow diagram of the respond process wherein an action plan is generated based on the set of talking points from FIG. 5 and the customer's reaction to those talking points.

### DETAILED DESCRIPTION

The following detailed description includes references to the accompanying drawings, which form a part of the detailed description. The drawings show illustrations in accordance with example embodiments. Note that in the description, references to “one embodiment” or “an embodiment” mean that the feature being referred to is included in at least one embodiment of the invention. Further, separate references to “one embodiment” in this description do not necessarily refer to the same embodiment; and, neither are such embodiments mutually exclusive, unless so stated and except as will be readily apparent to those of ordinary skill in the art. These embodiments, which are also referred to herein as “examples,” are described in enough detail to enable those skilled in the art to practice the invention. Thus, the present invention can include any variety of combinations and/or integrations of the embodiments described herein. Moreover, in this description, the phrase “exemplary embodiment” means that the embodiment being referred to serves as an example or illustration

It will be apparent to one skilled in the art that specific details in the example embodiments are not required in order to practice the present invention. For example, although the example embodiments are mainly disclosed with reference to a system for making financial decisions, the teachings can be used in other decision environments. The example embodiments may be combined, other embodiments may be utilized, or structural, logical and electrical changes may be made without departing from the scope what is claimed. The following detailed description is, therefore, not to be taken in a limiting sense, and the scope is defined by the appended claims and their equivalents.

The following disclosure will set forth some data structures that may be used in various embodiments. To provide the most clarity possible, data structures are defined without any commonly used technical structures (e.g. record types, file headers and footers, advisor and client identification numbers, codes for use in database management, etc.) or change/audit tracking data (e.g. date, time, user, etc.).

In this document, the terms “a” or “an” are used, as is common in patent documents, to include one or more than one. In this document, the term “or” is used to refer to a nonexclusive or, such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

Computer Systems

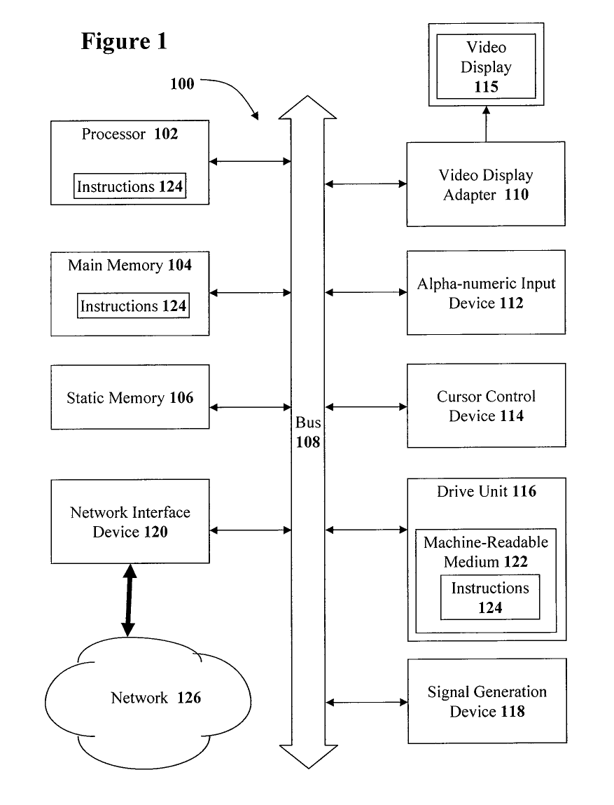

The present disclosure describes systems that may be implemented using computer systems. FIG. 1 illustrates a diagrammatic representation of machine in the example form of a computer system 100 that may be used to implement portions of the present disclosure. Within computer system 100 there are a set of instructions 124 that may be executed for causing the machine to perform any one or more of the methodologies discussed herein. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 100 includes a processor 102 (e.g., a central processing unit (CPU), a graphics processing unit (GPU) or both), a main memory 104 and a static memory 106, which communicate with each other via a bus 108. The computer system 100 may further include a video display adapter 110 that drives a video display system 115 such as a Liquid Crystal Display (LCD) or a Cathode Ray Tube (CRT). The computer system 100 also includes an alphanumeric input device 112 (e.g., a keyboard), a cursor control device 114 (e.g., a mouse or trackball), a disk drive unit 116, a signal generation device 118 (e.g., a speaker) and a network interface device 120.

The disk drive unit 116 includes a machine-readable medium 122 on which is stored one or more sets of computer instructions and data structures (e.g., instructions 124 also known as ‘software’) embodying or utilized by any one or more of the methodologies or functions described herein. The instructions 124 may also reside, completely or at least partially, within the main memory 104 and/or within the processor 102 during execution thereof by the computer system 100, the main memory 104 and the processor 102 also constituting machine-readable media.

The instructions 124 may further be transmitted or received over a network 126 via the network interface device 120. Such transfers may occur utilizing any one of a number of well-known transfer protocols such as the well known File Transport Protocol (FTP).

While the machine-readable medium 122 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies described herein, or that is capable of storing, encoding or carrying data structures utilized by or associated with such a set of instructions. The term “machine-readable medium” shall accordingly be taken to include, but not be limited to, solid-state memories, optical media, and magnetic media.

For the purposes of this specification, the term “module” includes an identifiable portion of code, computational or executable instructions, data, or computational object to achieve a particular function, operation, processing, or procedure. A module need not be implemented in software; a module may be implemented in software, hardware/circuitry, or a combination of software and hardware.

Customer Relationship Management

Different people will often react very differently to the same set of events. Thus, when providing services to different customers, it is important to understand each individual customer as much as possible so that one can provide the best service to each individual customer. To help keep track of such customer information and use that information most effectively, an entire category of software known as Customer Relationship Management (CRM) software was created. Customer relationship management software aims to help a business develop a customer-centric business strategy with the goal of maximizing profitability, revenue, and customer satisfaction. The Customer relationship management software industry has grown into a multi-billion dollar industry.

Customer relationship management software generally operates by collecting customer information and then using that information effectively. For example, customer information such as customer contact information, the products and services that the customer is currently using, this size of the customer, the customer's area of business, and other specifics are collected and stored in a database. Then, whenever there is communication with the customer, all of this collected information will be available to the person communicating with the customer. This greatly increases the efficiency of the communication with the customer since no time will be wasted familiarizing the person contacting the customer with the customer's current situation.

Customer relationship management software has proven to be very effective but it generally operates at a very simple level. Specifically, the information about customers is collected and that information is used with pre-defined scripts for customer management. Thus, although customer relationship management software has greatly improved matters, there is room for much improvement.

Psychology Based Customer Relationship Management

Psychology has been a subject of scientific study for hundreds of years. In recent years, scientists have been researching brain functions and psychology in order to determine the impact these functions have on personal decision making. Specifically, the emerging field of neuroeconomics combines neuroscience, economics, and psychology to study how humans make choices. Neuroeconomics looks at the role of the brain when humans evaluate decisions, categorize risks and rewards, and interact with each other.

The present disclosure proposes using this research for the creation of much more sophisticated customer relationship management programs. For example, this research can be applied to providing financial advisory services and integrated into automated financial advisory workflows.

The overall approach will be roughly similar to existing customer relationship management (CRM) software systems in that information on customers will be collected and that customer information will be analyzed and used to guide future interaction with that customer. However, the specific type of information that is collected will differ and the manner in which that collected information is processed and used will differ.

To best disclose the teachings of this document, an example embodiment will be presented for providing financial advisory services in view of a set of neuroeconomics factors collected from an investment advisor and a client. However, this example is no meant to limit the teachings in anyway.

Neuroeconomics-Based Financial Advisory Services Overview

The first aspect of a neuroeconomics-based financial advisory service system is a database of relevant information. Much of the database will concern neuroeconomic information about a customer such as detailed information about the customer including factors that describe the psychology of the customer. The neuroeconomic information about the customer will be used to create a behaviour advisory plan for the customer. Since another human will be involved in interactions with a customer, a financial services advisor in this example embodiment, detailed information on the financial service advisor should also be collected. That information may be used to create a behaviour advisory profile for the financial services advisor.

After collecting all of the necessary information, a ‘recognize process’ is then invoked. The recognize process monitors various streams information and may be used to trigger a ‘freeze moment’ when the current set of decisions may need to be re-considered. A ‘reflect process’ may then be invoked. The reflect process creates a summary of the cognitive, emotional, and physical impacts on investment decision making.

Finally, a ‘reframe process’ and ‘respond process’ may then be invoked. The reframe process considers the customer information and the current situation in order to generate talking points and scripts that ma be used by financial service advisors when communicating with a particular customer. The respond process helps the financial service advisor create an action plan after communicating with the customer using the information generated by the reframe process.

Financial Advisor Behavioral Advisory Profile

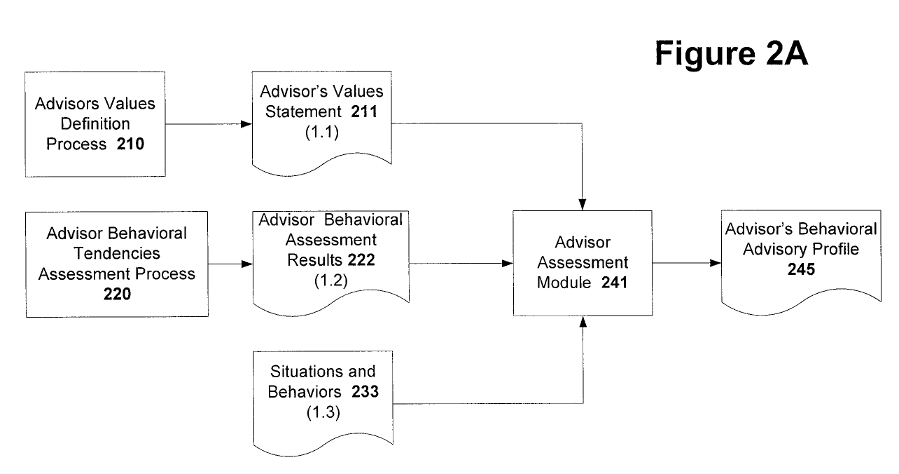

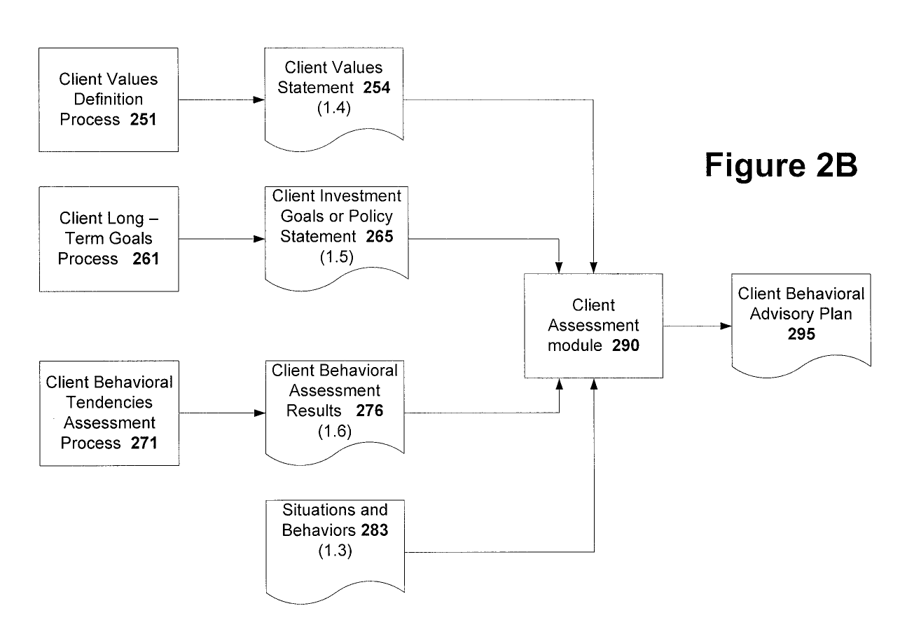

As set forth earlier, the psychology and competencies of each individual financial service advisor will have an effect on the final decisions made by a financial services customer. Thus, the system of the present disclosure collects detailed information on each financial service advisor and builds a behavioral advisory profile for each financial service advisor. FIG. 2A illustrates a high level flow diagram of one embodiment of a process used to create a “Behavioral Advisory Profile” for individual advisors.

Referring to the top left of FIG. 2A, each financial service advisor may submit to an advisors values definition process 210 with a goal of quantifying the financial service advisor's values. In one embodiment, the advisors values definition process 210 requires financial service advisors to narrow down their values to five core values. The output of the advisors values definition process 210 is an advisor's values statement 211. In one embodiment, the an advisor's values statement 211 can be represented as data structure containing the following fields: Advisor Name, Top five Values of Advisor (created from a group of 30 values using the Values Cards exercise), Values Statement, and Perfect Day Description as set forth in the following data structure:

Data Structure 1.1 - Advisors Value Statement

| | | Field | |
|---|---|---|---|
| Data Element | Description | Format | Length |
| Advisor Name, | Last Name of Advisor | Char | 30 |
| Last | | | |
| Advisor Name, | First Name of Advisor | Char | 30 |
| First | | | |
| Values Statement | A written statement describing | Char | 500 |
| | the values of each advisor | | |
| Perfect Day | A written statement describing | Char | 500 |
| Description | an advisors “Perfect Day” | | |
| Adventure | Defines whether value is a “Top 5” | Y/N | 1 |
| Autonomy | Defines whether value is a “Top 5” | Y/N | 1 |
| Challenges | Defines whether value is a “Top 5” | Y/N | 1 |
| Change | Defines whether value is a “Top 5” | Y/N | 1 |
| Community | Defines whether value is a “Top 5” | Y/N | 1 |
| Competence | Defines whether value is a “Top 5” | Y/N | 1 |
| Competition | Defines whether value is a “Top 5” | Y/N | 1 |
| Cooperation | Defines whether value is a “Top 5” | Y/N | 1 |
| Creativity | Defines whether value is a “Top 5” | Y/N | 1 |
| Decisiveness | Defines whether value is a “Top 5” | Y/N | 1 |
| Diversity | Defines whether value is a “Top 5” | Y/N | 1 |
| Ecology/ | Defines whether value is a “Top 5” | Y/N | 1 |
| environment | | | |
| Education | Defines whether value is a “Top 5” | Y/N | 1 |
| Ethics | Defines whether value is a “Top 5” | Y/N | 1 |
| Excellence | Defines whether value is a “Top 5” | Y/N | 1 |
| Excitement | Defines whether value is a “Top 5” | Y/N | 1 |
| Fairness | Defines whether value is a “Top 5” | Y/N | 1 |
| Fame | Defines whether value is a “Top 5” | Y/N | 1 |
| Family | Defines whether value is a “Top 5” | Y/N | 1 |
| Flexibility | Defines whether value is a “Top 5” | Y/N | 1 |
| Freedom | Defines whether value is a “Top 5” | Y/N | 1 |
| Friendship | Defines whether value is a “Top 5” | Y/N | 1 |
| Happiness | Defines whether value is a “Top 5” | Y/N | 1 |
| Health | Defines whether value is a “Top 5” | Y/N | 1 |
| Helping Others | Defines whether value is a “Top 5” | Y/N | 1 |
| Honesty | Defines whether value is a “Top 5” | Y/N | 1 |
| Independence | Defines whether value is a “Top 5” | Y/N | 1 |
| Integrity | Defines whether value is a “Top 5” | Y/N | 1 |
| Leadership | Defines whether value is a “Top 5” | Y/N | 1 |
| Loyalty | Defines whether value is a “Top 5” | Y/N | 1 |
| Meaningful Work | Defines whether value is a “Top 5” | Y/N | 1 |
| Money | Defines whether value is a “Top 5” | Y/N | 1 |
| Order | Defines whether value is a “Top 5” | Y/N | 1 |
| Philanthropy | Defines whether value is a “Top 5” | Y/N | 1 |
| Play | Defines whether value is a “Top 5” | Y/N | 1 |
| Pleasure | Defines whether value is a “Top 5” | Y/N | 1 |
| Power | Defines whether value is a “Top 5” | Y/N | 1 |
| Privacy | Defines whether value is a “Top 5” | Y/N | 1 |
| Recognition | Defines whether value is a “Top 5” | Y/N | 1 |
| Relationships | Defines whether value is a “Top 5” | Y/N | 1 |
| Religion | Defines whether value is a “Top 5” | Y/N | 1 |
| Safety | Defines whether value is a “Top 5” | Y/N | 1 |
| Security | Defines whether value is a “Top 5” | Y/N | 1 |
| Service | Defines whether value is a “Top 5” | Y/N | 1 |
| Spirituality | Defines whether value is a “Top 5” | Y/N | 1 |
| Stability | Defines whether value is a “Top 5” | Y/N | 1 |
| Status | Defines whether value is a “Top 5” | Y/N | 1 |
| Wealth | Defines whether value is a “Top 5” | Y/N | 1 |
| Work | Defines whether value is a “Top 5” | Y/N | 1 |

Next, each financial service advisor further may submit to an advisor behavioral tendencies assessment process 220. The goal of the advisor behavioral tendencies assessment process 220 is to quantify the financial service advisor's behavioral tendencies. The advisor behavioral tendencies assessment process 220 helps define the behaviors an advisor is likely to demonstrate under various circumstances. The output of the advisor behavioral tendencies assessment process 220 is a set of advisor behavioral assessment results 222.

In one embodiment, the advisor behavioral assessment results 222 may be presented in a data structure containing the following fields: Competency, Behaviors, and Competency Score. The field of Emotion Intelligence has identified a large number of different competencies. In one embodiment, a subset of competencies that describe characteristics most related to performance were selected. Each competency is listed along with behavior required to exhibit the competency. Finally, a score is assigned for each competency exhibited by a financial services advisor. An example data structure that can be used to store information on each competency defined in the assessment tool is set forth below:

### Data Structure 1.2—Behavioral Assessment Results

| | | Field | |
|---|---|---|---|
| Data Element | Description | Format | Length |
| Advisor Name, | Last Name of Advisor | Char | 30 |
| Last | | | |
| Advisor Name, | First Name of Advisor | Char | 30 |
| First | | | |
| Competency | Describes a behavioral advisory | Char | 20 |
| | competency (e.g. empathy) | | |
| Behavior | Describes the behavior required to | Char | 20 |
| | exhibit Competency A (e.g. listening) | | |
| Score | The score shows the relative | Number | 3 |
| | effectiveness of the advisor in these | | |
| | competencies and behaviors (0-100) | | |

The competency scores in the advisor behavioral assessment results 222 may be assigned using various different means. In an example, an interview can be conducted with each financial services advisor with an interviewer that is trained in Behavior Event Interviewing (BEI). The interviewer would then score the financial services advisor based on competencies exhibited in the interview. Details on Behavior Event Interviewing can be found in the book “The Competent Manager: A Model for Effective Performance”, by Richard E. Boyatzis, Wiley (January 1982). Additional information can be found in the book “Competence at Work: Models for Superior Performance”, by Lyle M. Spencer and Signe M. Spencer, Wiley (March 1993).

Alternatively, various competency scores can be assigned to financial service advisors using an assessment tool. In one embodiment, the assessment tool presents the financial advisors with a series of situations along with various methods of handling the presented situations. The assessment tool will score the financial service advisor's handling selections along a set of competencies. The competency scores will then be entered into the system.

As set forth above, the advisor behavioral assessment results 222 defines the behavior a financial services advisor is likely to demonstrate under various circumstances. A set of example circumstances can be collected into a data structure such as the following:

### Data Structure 1.3—Situations and Behaviors

| | | Field | |
|---|---|---|---|
| Data Element | Description | Format | Length |
| Situation | A description of anticipated situations | Char | 250 |
| Behavior | Behaviors that are likely to be needed | Char | 20 |
| Required | | | |

All of the information collected about financial service advisors can be combined to create a complete financial advisor behavioral advisory profile 245. Referring back to FIG. 2A, Advisor Assessment Module 241 combines an advisor's values statement 211 and the advisor behavioral assessment results 222 into an electronic profile (advisor behavioral advisory profile 245) that describes the way the financial service advisor is likely to respond in certain situations.

Customer Behavioral Advisory Plan

The system of the present disclosure carefully assesses each customer in order to create a behavioral profile of that customer. (Note that since the example embodiment presented in the disclosure deals with financial services, the word “client” will be used interchangeably with the word “customer”.) FIG. 2B illustrates the process used to create a behavioral advisory plan 295 for each individual client.

Each customer/client may be subjected to a client values definition process 251 In one particular embodiment, the client values definition process 251 is similar to the advisors values definition process 210 described in the previous section with reference to FIG. 2A. The client values definition process 251 requires clients to narrow down their values to a set of five core values. The output of the client values definition process 251 is a client values statement 254.

In one embodiment, the client values statement 254 can be expressed as a data structure containing the following fields: Client Name, Top five Values of Client (that may be selected from a group of 30 values, Values Statement, and a Perfect Day Description. The following data structure presents one possible example data structure that may be used to represent client values:

### Data Structure 1.4—Client Values Statement

| | | Field | |
|---|---|---|---|
| Data Element | Description | Format | Length |
| Client Name, Last | Last Name of Client | Char | 30 |
| Client Name, | First Name of Client | Char | 30 |
| First | | | |
| Values Statement | A written statement describing | Char | 500 |
| | the values of each advisor | | |
| Perfect Day | A written statement describing | Char | 500 |
| Description | an advisors “Perfect Day” | | |
| Adventure | Defines whether value is a “Top 5” | Y/N | 1 |
| Autonomy | Defines whether value is a “Top 5” | Y/N | 1 |
| Challenges | Defines whether value is a “Top 5” | Y/N | 1 |
| Change | Defines whether value is a “Top 5” | Y/N | 1 |
| Community | Defines whether value is a “Top 5” | Y/N | 1 |
| Competence | Defines whether value is a “Top 5” | Y/N | 1 |
| Competition | Defines whether value is a “Top 5” | Y/N | 1 |
| Cooperation | Defines whether value is a “Top 5” | Y/N | 1 |
| Creativity | Defines whether value is a “Top 5” | Y/N | 1 |
| Decisiveness | Defines whether value is a “Top 5” | Y/N | 1 |
| Diversity | Defines whether value is a “Top 5” | Y/N | 1 |
| Ecology/ | Defines whether value is a “Top 5” | Y/N | 1 |
| environment | | | |
| Education | Defines whether value is a “Top 5” | Y/N | 1 |
| Ethics | Defines whether value is a “Top 5” | Y/N | 1 |
| Excellence | Defines whether value is a “Top 5” | Y/N | 1 |
| Excitement | Defines whether value is a “Top 5” | Y/N | 1 |
| Fairness | Defines whether value is a “Top 5” | Y/N | 1 |
| Fame | Defines whether value is a “Top 5” | Y/N | 1 |
| Family | Defines whether value is a “Top 5” | Y/N | 1 |
| Flexibility | Defines whether value is a “Top 5” | Y/N | 1 |
| Freedom | Defines whether value is a “Top 5” | Y/N | 1 |
| Friendship | Defines whether value is a “Top 5” | Y/N | 1 |
| Happiness | Defines whether value is a “Top 5” | Y/N | 1 |
| Health | Defines whether value is a “Top 5” | Y/N | 1 |
| Helping Others | Defines whether value is a “Top 5” | Y/N | 1 |
| Honesty | Defines whether value is a “Top 5” | Y/N | 1 |
| Independence | Defines whether value is a “Top 5” | Y/N | 1 |
| Integrity | Defines whether value is a “Top 5” | Y/N | 1 |
| Leadership | Defines whether value is a “Top 5” | Y/N | 1 |
| Loyalty | Defines whether value is a “Top 5” | Y/N | 1 |
| Meaningful Work | Defines whether value is a “Top 5” | Y/N | 1 |
| Money | Defines whether value is a “Top 5” | Y/N | 1 |
| Order | Defines whether value is a “Top 5” | Y/N | 1 |
| Philanthropy | Defines whether value is a “Top 5” | Y/N | 1 |
| Play | Defines whether value is a “Top 5” | Y/N | 1 |
| Pleasure | Defines whether value is a “Top 5” | Y/N | 1 |
| Power | Defines whether value is a “Top 5” | Y/N | 1 |
| Privacy | Defines whether value is a “Top 5” | Y/N | 1 |
| Recognition | Defines whether value is a “Top 5” | Y/N | 1 |
| Relationships | Defines whether value is a “Top 5” | Y/N | 1 |
| Religion | Defines whether value is a “Top 5” | Y/N | 1 |
| Safety | Defines whether value is a “Top 5” | Y/N | 1 |
| Security | Defines whether value is a “Top 5” | Y/N | 1 |
| Service | Defines whether value is a “Top 5” | Y/N | 1 |
| Spirituality | Defines whether value is a “Top 5” | Y/N | 1 |
| Stability | Defines whether value is a “Top 5” | Y/N | 1 |
| Status | Defines whether value is a “Top 5” | Y/N | 1 |
| Wealth | Defines whether value is a “Top 5” | Y/N | 1 |
| Work | Defines whether value is a “Top 5” | Y/N | 1 |

Next, the customer/client's long term investment goals are assessed in a client long-term goals process 261. The client long-term goals process 261 may follows standard investment industry practices by examining risk tolerances, return expectations, and time horizons to define client investment goals. The output of the client long-term goals process 261 is a client investment goals or policy statement 265.

The client investment goals or policy statement 265 may be expressed in a data structure containing from a financial advisory firm's Client Investment Goals or Client Investment Policy Statement that are very common in the financial services industry. This information commonly contains elements concerning client's investment objectives, return expectations, time horizons and investment products. This data is manually entered into the system and will be unique based on the data available for each different financial advisory firm.

Finally, the customer/client may be put through a client behavioral tendencies assessment process 271. The client behavioral tendencies assessment process 271 helps define the behaviors a client is likely to demonstrate under various circumstances. The client behavioral tendencies assessment process 271 may be similar to (or the same as) the advisor behavioral tendencies assessment process 220 set forth earlier.

The output of the client behavioral tendencies assessment process 271 is a set of client behavioral assessment results 276. The client behavioral assessment results 276 may be expressed with a data structure containing the following fields: Competency, Behaviors, and Competency Score. As set forth with respect to the financial services advisor behavioral tendencies assessment process 220, the client behavioral tendencies assessment process 271 may generate these scores manually by interviewing the clients or it may be using an assessment tool. In one embodiment, the client behavioral assessment results 276 may be stored in the following data structure:

### Data Structure 1.6—Client Behavioral Assessment Results

| | | Field | |
|---|---|---|---|
| Data Element | Description | Format | Length |
| Client Name, | Last Name of Client | Char | 30 |
| Last | | | |
| Client Name, | First Name of Client | Char | 30 |
| First | | | |
| Competency | Describes a behavioral advisory | Char | 20 |
| | competency (e.g. empathy) | | |
| Behavior | Describes the behavior required to | Char | 20 |
| | exhibit Competency A (e.g. listening) | | |
| Score | The score shows the relative | Number | 3 |
| | effectiveness of the advisor in these | | |
| | competencies and behaviors (0-100) | | |

The various circumstances that the client behavioral tendencies assessment process 271 deals with may be the same circumstances handled by the financial advisor behavioral tendencies assessment process 220. Thus, the set of example circumstances collected into Data Structure 1.3 may also be used for evaluating clients/customer.

All of the information collected about a customer/client may be combined to create a full client behavioral advisory plan 295. Referring back to FIG. 2A, a client assessment module 290 combines client values statement 254, client investment goals or policy statement 265, behavioral assessment results 276, and situations and behaviors 283 into an electronic profile of a client behavioral advisory plan 295 for the client. The client behavioral advisory plan 295 describes the way the customer/client is likely to respond in certain situations and a general plan of how the client's investments should be handled.

The Recognize Process—Advisor Driven

Once a client has been entered into the system and the client's initial investment decisions have been made, the system of the present disclosure can be used to determine when the client's investment decisions should be revisited. This is known as the recognize process. The recognize process is used to recognize and document the need to examine a situation for the behavioral advisory impact. Various different events may trigger the recognize process analysis. This document describes two different systems: an advisor driven system and an event driven system. The remainder of this section describes the advisor driven system.

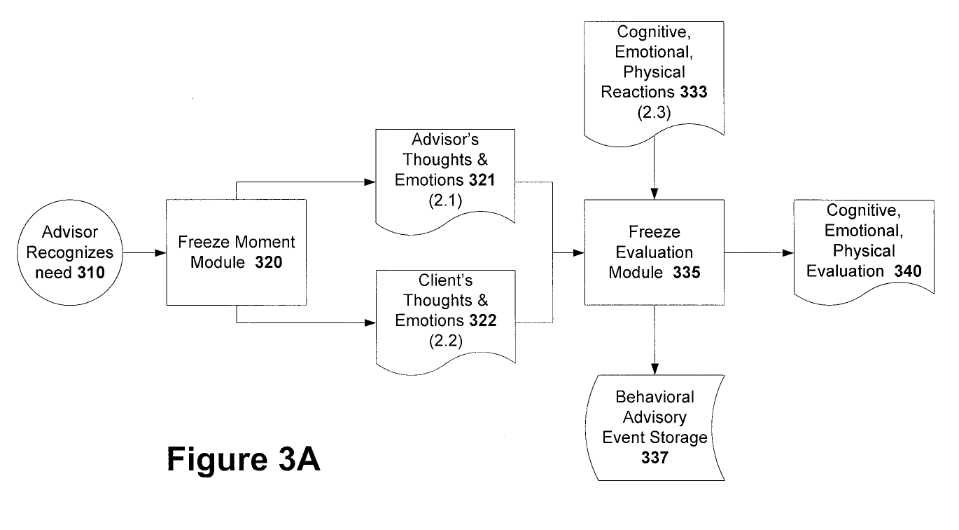

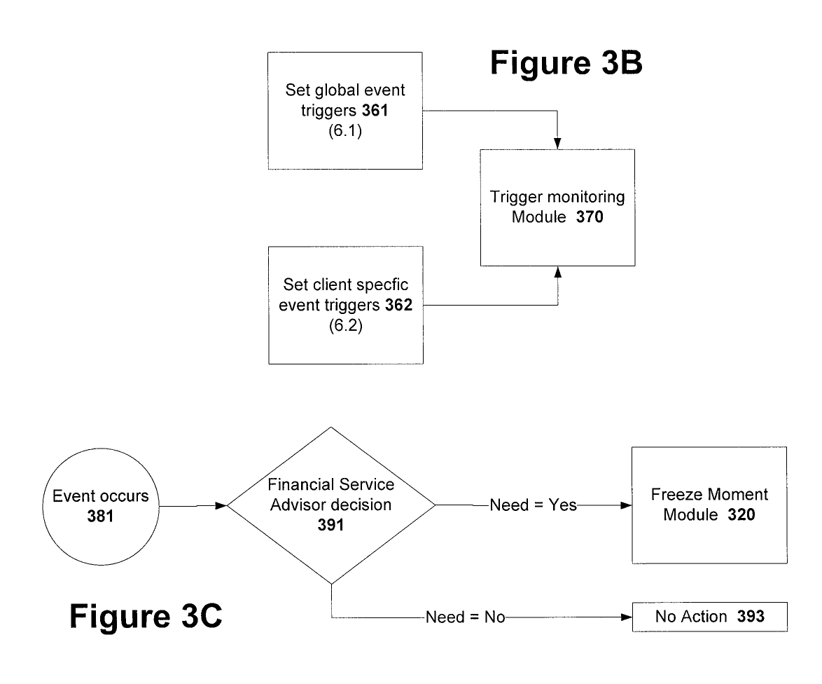

FIG. 3A illustrates the example when an advisor recognizes the need to engage the recognize process. Referring to FIG. 3A, a financial services advisor may recognize a need 310 and can trigger a “Freeze Moment” using freeze moment module 320. This process allows a financial service advisor to recognize and electronically document thoughts and emotions regarding the current situation. In one embodiment, the freeze moment module 320 also allows the financial advisor to electronically document the financial advisor's own thoughts and emotions as well as the thoughts and emotions of clients. Freeze moment module 320 creates an electronic record of these thoughts and emotions and provides an evaluation of the cognitive, emotional and physical activities occurring in both the advisor and the client.

The financial service advisor's thoughts and emotions are chronicled in an advisor's thoughts and emotions record 321. The advisor's thoughts and emotions record 321 may comprise a data structure containing fields for the financial service advisor to note their thoughts and emotions. The advisor's thoughts and emotions record 321 may also contain a list of emotions that a financial service advisor can choose from to note his current emotional state. A financial service advisor may select be multiple emotions. The advisor's thoughts and emotions record 321 may be represented by the following data structure:

Data Structure 2.1 - Advisor's Thoughts and Emotions

| | | Field | |
|---|---|---|---|
| Data Element | Description | Format | Length |
| Advisor Name, | Last Name of Advisor | Char | 30 |
| Last | | | |
| Advisor Name, | First Name of Advisor | Char | 30 |
| First | | | |
| Emotions | Description of current emotional state | Char | 250 |
| Thoughts | Description of current thoughts | Char | 250 |
| Emotion ## | Defines whether emotion is currently | Y/N | 1 |
| | part of emotional state | | |
| . | . | | |
| . | . | | |
| . | . | | |
| Emotion ## | Defines whether emotion is | Y/N | 1 |
| | currently part of emotional state | | |

Similarly, the client's thoughts and emotions may be recorded in a client's thoughts and emotions record 322. The financial service advisor may manually note the thoughts and emotions of clients and store these in client's thoughts and emotions record 322. The client's thoughts and emotions record 322 also contains a list of emotions that advisors can choose to note their clients' current emotional state. A financial service advisory may specify multiple emotions for each client. The following data structure may be used to represent client's thoughts and emotions record 322:

### Data Structure 2.2—Client's Thoughts and Emotions

| | | Field | |
|---|---|---|---|
| Data Element | Description | Format | Length |
| Client Name, Last | Last Name of Client | Char | 30 |
| Client Name, First | First Name of Client | Char | 30 |
| Emotions | Description of current emotional | Char | 250 |
| | state | | |
| Thoughts | Description of current thoughts | Char | 250 |

| | | Field | |
|---|---|---|---|
| Data Element | Description | Format | Length |
| Emotion ## | Defines whether emotion is currently | Y/N | 1 |
| | part of emotional state | | |
| . | . | | |
| . | . | | |
| . | . | | |
| Emotion ## | Defines whether emotion is currently | Y/N | 1 |
| | part of emotional state | | |

In addition to the customer/client's thoughts and emotions record 322, the client's physiological state may also be collected in cognitive, emotional and physical reactions record 333. A data structure for cognitive, emotional and physical reactions record 333 may include but is not limited to emotion, physiological state, brain chemistry reactions, heart rate, breathing patterns and tension levels. For example, the following data structure may be used for the cognitive, emotional and physical reactions record 333:

### Data Structure 2.3—Cognitive, Emotional and Physical Reactions

| | | Field | |
|---|---|---|---|
| Data Element | Description | Format | Length |
| Emotion | Description of emotion | Char | 30 |
| Brain | Defines brain chemistry reaction to | Char | 200 |
| Chemistry | emotion | | |
| Heart Rate | Defines heart rate reaction to emotion | Char | 200 |
| Breathing | Defines breathing pattern reaction to | Char | 200 |
| Pattern | emotion | | |
| Tension Level | Defines tension level reaction to | Char | 200 |
| | emotion | | |

After all the freeze moment information has been collected, the freeze moment information may be analyzed with freeze moment evaluation module 335. The freeze moment evaluation module 335 takes information from the advisor's thoughts and emotions record 321, the client's thoughts and emotions record 322, and the cognitive, emotional and physical reactions record 333 to create a cognitive, emotional and physical evaluation 340 of the freeze moment. The freeze moment evaluation module 335 also stores this data into a history database known as the behavioral advisory event storage 337.

The Recognize Process—Advisor Driven

Instead of having an advisor trigger the recognize process, a set of automated triggers may be used to the recognize process. FIG. 3B illustrates the process used to create a set of “Freeze Moment Alerts” that will be generated systematically.

A financial service advisor will first define a set of global event triggers 361. The set of global event triggers 361 may be defined by a data structure that contains a checklist of conditions that could trigger the need to use the recognize process. The checklist would contain but not be limited to items such as percentage decrease in the market or sector of the market, percentage increase in the market or sector of the market, and general news events. The set of global event triggers 361 would also store the notification type preferred by the financial service advisor (e.g. email, text message). In one embodiment, the following data structure could be used to define the set of global event triggers 361:

### Data Structure 6.1—Global Event Triggers

| | | Field | |
|---|---|---|---|
| Data Element | Description | Format | Length |
| Advisor Name, Last | Last Name of Advisor | Char | 30 |
| Advisor Name, First | First Name of Advisor | Char | 30 |
| Email Advisor | Email | Y/N | 1 |
| Text Message | Text Message | Y/N | 1 |
| Event Data | Description of Event Data | Char | 30 |
| Event Symbol | Symbol for security | Char | 5 |
| Data Trigger | Quantity change | Number | 9 |
| Direction | Increase or decrease | Number | 1 |
| Percentage Trigger | Percentage change | Number | 3 |
| Percentage Direction | Increase or decrease | Number | 1 |
| News Trigger | Symbol for news trigger | Char | 5 |

In addition to the set of global event triggers, financial service advisors may wish to create a set of client specific events that pertain to specific clients. This set of client specific triggers 362 could be very similar to the global even triggers. In addition, a data structure for the client specific triggers 362 could also contain items regarding the change in the clients' accounts such as marital status, change of address or additional beneficiaries. In one embodiment, the following data structure could be used to define the set of client specific triggers 362:

### Data Structure 6.2—Client Specific Event Triggers

| | | Field | |
|---|---|---|---|
| Data Element | Description | Format | Length |
| Client Name, Last | Last Name of Client | Char | 30 |
| Client Name, First | First Name of Client | Char | 30 |
| Email Advisor | Email | Y/N | 1 |
| Text Message | Text Message | Y/N | 1 |
| Event Data | Description of Event Data | Char | 30 |
| Event Symbol | Symbol for security | Char | 5 |
| Event Data Trigger | Quantity change | Number | 9 |
| Event Direction | Increase or decrease | Number | 1 |
| Event Data Trigger | Percentage change | Number | 3 |
| Event Direction | Increase or decrease | Number | 1 |
| News Trigger | Symbol for news trigger | Char | 5 |

After creating the set of global event triggers 361 and the set of client specific triggers 362 trigger monitoring module 370 would monitor various data sources generally available to financial service advisors (electronic news feeds, market data feeds, account information, etc.) to determine if any of the specified trigger events occur.

FIG. 3C illustrates a flow chart that illustrates how trigger events are handled when trigger events occur. When a trigger event occurs 381, trigger monitoring module 370 may send electronic alerts to the financial service advisor suggesting that the financial service advisor trigger the recognize Process. The financial service advisor could then analyze the events that triggered the alert (such as market movements, news events, etc.) to determine if a “Freeze Moment Alert” should be generated. Depending upon the financial service advisor decision 391, the Freeze Moment Module 320 of FIG. 3A may be activated or no action may be taken 393.

The Reflect Process

After each freeze moment, a reflect process may be may then be invoked. The reflect process analyzes the information disclosed in previous sections to create a summary of the cognitive, emotional, and physical impacts on investment decision making 470.

The reflect process uses databases that reflect how various emotions, competencies may effect decision making. A first database contains data structures that define the relationships between competencies and emotions. Note there can be multiple emotions for each competency. In one embodiment, the following data structure is used to define these relationships:

### Data Structure 3.1—Competency Emotions Relationships

| Data | | Field | |
|---|---|---|---|
| Element | Description | Format | Length |
| Competency | Describes a behavioral advisory | Char | 20 |
| | competency (e.g. empathy) | | |
| Emotion ## | Defines whether competency is affected | Y/N | 1 |
| | by specific emotion | | |
| . | . | | |
| . | . | | |
| . | . | | |
| Emotion ## | Defines whether competency is | Y/N | 1 |
| | affected by specific emotion | | |

A second database contains data structures that define the relationships between emotions and the impact that such emotions may have on decisions. Note that there can be multiple decision impacts for each different emotion. In one embodiment, the following data structure is used to define the relationships between emotions and decision impacts:

### Data Structure 3.2—Emotions Decision Relationships

| | | Field | |
|---|---|---|---|
| Data Element | Description | Format | Length |
| Emotion | Describes a behavioral advisory | Char | 20 |
| | competency (e.g. empathy) | | |
| Decision | Defines how emotion affects decision | Char | 200 |
| Impact ## | | | |
| . | . | | |
| . | . | | |
| . | . | | |
| Decision | Defines how emotion affects decision | Char | 200 |
| Impact ## | | | |

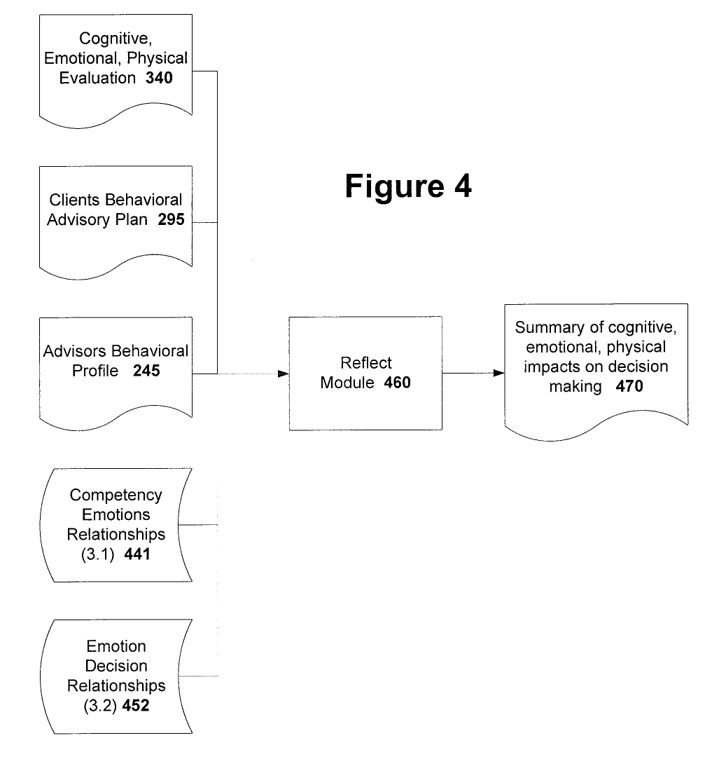

FIG. 4 illustrates one embodiment of the reflect process. In the reflect process of FIG. 4, reflect module 460 analyzes the outputs from the prior process to create a summary that shows how the decision-making sections of the brain are affected and may impact any investment decision making. Specifically, reflect module 460 analyzes the advisor behavioral advisory profile 245, the client behavioral advisory plan 295, and the cognitive, emotional and physical evaluation 340 of the freeze moment in view of the two preceding databases in order to create the summary of the cognitive, emotional, and physical impacts on investment decision making 470 that describes the impact that all of this data has on decision making in general terms.

The Reframing Process

After processing the freeze moment information with the reflect process, a reframe process reframes the matter in order to create a set of advisory talking points and/or a script for communicating with the customer/client. The reframe process may operate by starting from a set of existing talking points and customer scripts 511 and modifying those existing talking points and customer scripts 511.

The existing talking points and customer scripts 511 may be represented in a data structure that contains decision impacts, investment objectives and suggested talking points and scripts for use by the advisor in interactions with clients. There can be multiple talking points per decision impact. In one embodiment, the following data structure is used to represent existing talking points and customer scripts 511:

### Data Structure 4.1—Advisory Talking Points and Scripts

| | | Field | |
|---|---|---|---|
| Data Element | Description | Format | Length |
| Decision Impact | Defined decision impacts. | Char | 200 |
| Investment Objective | Investment Objectives from | Char | 20 |
| | client's profiles. | | |
| Talking Point ## | Suggested language/script | Char | 200 |
| | for advisors to use with clients | | |
| . | . | | |
| . | . | | |
| . | . | | |
| Talking Point ## | Suggested language/script | Char | 200 |
| | for advisors to use with clients | | |

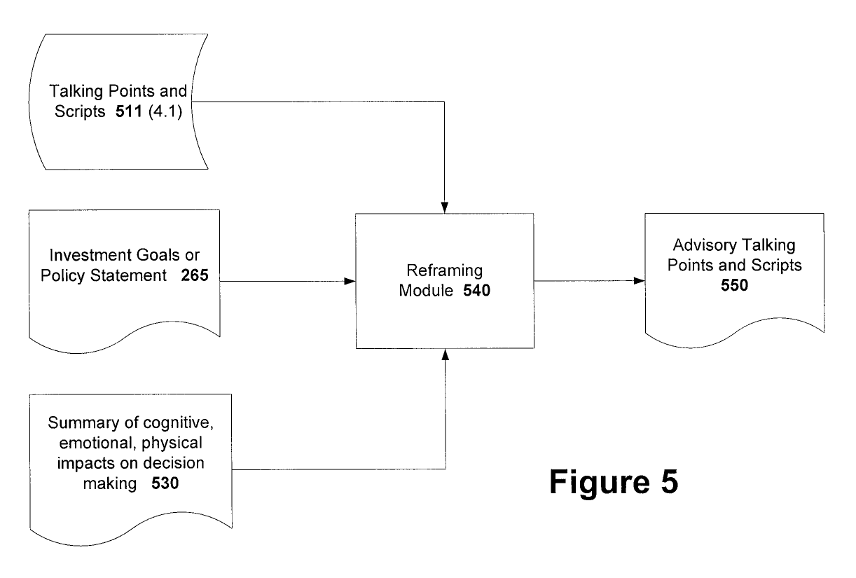

FIG. 5 illustrates the Reframing Process. A reframing module 540 takes input from the investment goals or policy statement 265 (previous described in FIG. 2B and the accompanying text) and the summary of the cognitive, emotional, and physical impacts on investment decision making 470 (created by the reflect process of FIG. 4) to select examine the talking points and customer scripts library 511 and select a specific set of advisory talking points and customer scripts 550. Financial service advisors may then use the selected set of advisory talking points and customer scripts 550 to guide their clients through the decision-making needed for the current situation.

The Respond Process

The advisory talking points and customer scripts 550 created in FIG. 5 will be used in a presentation to the customer/client by the financial service advisor. The financial service advisor will collect the customer/client's reactions to the advisory talking points and customer scripts 550.

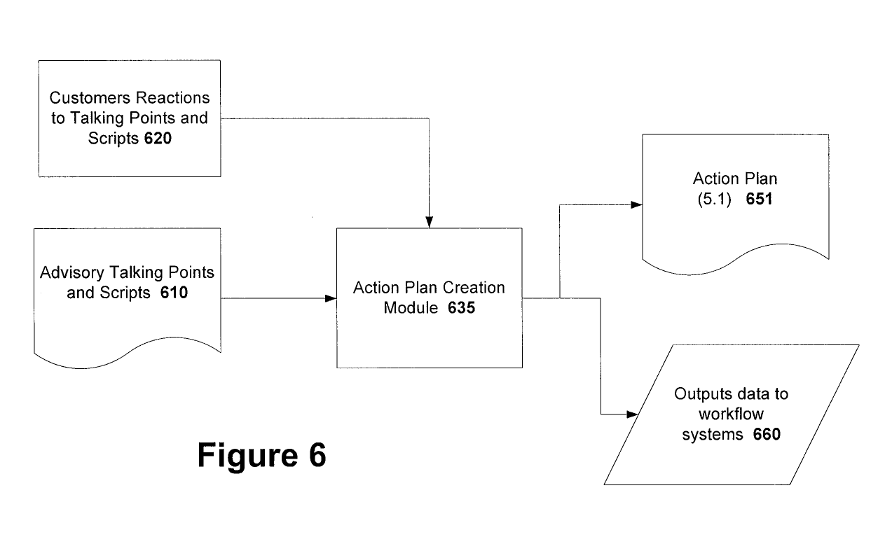

After the presentation to a customer, a respond process may create an action plan consisting of a set of suggested action items. FIG. 6 illustrates the respond process wherein an action plan creation module 635 defines the action items that may be needed based on the advisory talking points and customer scripts 550 created in FIG. 5 and the customer's reactions to the talking points and scripts 620. Specifically, action plan creation module 635 creates an electronic action plan 651 and communicates with the financial service advisor's workflow system (such as personal information management system that handles contacts, task lists, and a calendar) to create tasks, follow-up items, summary letters, and schedule any additional meetings with client as set forth in step 660. The specific data output will be determined based on the advisors specific customer relationship management (CRM) software and/or workflow system.

Using the action plan 651, a financial service advisor can then choose the appropriate investment adjustments steps based on conversations with clients. The action plan 651 may include investment mix adjustments, any other investment adjustment, the scheduling of follow-up meetings, the creation of new event triggers, or any adjustment to the disclosed financial investment system.

The preceding technical disclosure is intended to be illustrative, and not restrictive. For example, the above-described embodiments (or one or more aspects thereof) may be used in combination with each other. Other embodiments will be apparent to those of skill in the art upon reviewing the above description. The scope of the claims should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract is provided to comply with 37 C.F.R. §1.72(b), which requires that it allow the reader to quickly ascertain the nature of the technical disclosure. The abstract is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment.

What is claimed is:

1. A computer system comprising:
a processor configured to receive a set of customer information and a set of customer advisor information, the processor comprising:
a customer assessment module configured to generate a customer behavioral advisory profile; and
a customer advisor assessment module configured to generate a customer advisor behavioral advisory profile;
wherein the processor is configured to receive an event occurrence and render a set of talking points using the event occurrence, the customer behavioral advisory profile, and the customer advisor behavioral advisory profile.

2. The computer system of claim 1, wherein the processor is configured to create a set of customer specific event triggers using the set of customer information.

3. The computer system of claim 2, wherein the processor includes a trigger monitoring module configured to monitor the set of customer specific event triggers.

4. The computer system of claim 1, wherein the processor is configured to generate an action plan after rendering the set of talking points.

5. The computer system of claim 1, wherein the processor is configured to collect event reaction information from the customer and the customer advisor and create an evaluation after collecting the event reaction information.

6. The computer system of claim 5, wherein the processor is configured to generate a summary of decision making factors using the event reaction information, the set of customer information, and the set of customer advisor information.

7. The computer system of claim 1, wherein the processor is configured to collect the set of customer information, the customer information including a client values statement.

8. The computer system of claim 1, wherein the processor is configured to collect a set of customer advisor competencies and the assessment module is configured to score the set of customer advisor competencies.

9. A computer-readable medium comprising a set of computer instructions that, when executed on a computer system, implement the steps of:
collecting a set of customer information;
collecting a set of customer advisor information;
generating a customer behavioral advisory profile and a customer advisor behavioral advisory profile using the set of customer information and the set of customer advisor information; and
rendering a set of talking points using an event occurrence, the customer behavioral advisory profile, and the customer advisor behavioral advisory profile.

10. The computer-readable medium of claim 9, wherein the computer instructions further implement creating a set of customer specific event triggers using the set of customer information.

11. The computer-readable medium of claim 10, wherein the computer instructions further implement monitoring the set of customer specific event triggers using a plurality of information streams.

12. The computer-readable medium of claim 9, wherein the computer instructions further implement generating an action plan after rendering the set of talking points.

13. The computer-readable medium of claim 9, wherein the computer instructions further implement creating an evaluation after an event occurs using event reaction information collected from the customer and customer advisor after the event.

14. The computer-readable medium of claim 9, wherein the collecting the set customer information includes collecting a client values statement.

15. The computer-readable medium of claim 14, wherein the collecting the set of customer information includes:
collecting a set of customer advisor competencies; and
scoring the set of customer advisor competencies.

16. The computer-readable medium of claim 9, wherein the computer instructions further implement generating a summary of decision making factors using the event reaction information, the set of customer information, and the set of customer advisor information.

17. A computer implemented system for providing customer service comprising:
an information collection module configure to receive a set of customer information and a set of customer advisor information;
an event trigger monitoring module configured to monitor a plurality of information streams for a set of defined events;
an evaluation module for evaluating a customer reaction and a customer advisor reaction to an occurrence of one of the set of defined events;
a reflect module configured to generate a summary of decision making factors using the customer reaction and the customer advisor reaction the occurrence of the one of the set of defined events, the set of customer information, and the set of customer advisor information; and
a reframing module configured to generate a set of talking points for the customer advisor to use with the customer using the summary of decision making factors.

18. The computer implemented system of claim 17, wherein the set of customer advisor information includes a set of customer advisor competency scores.

19. The computer implemented system of claim 17 comprising an action plan creation module configured to receive a set of customer reactions to the set of talking points and to generate an action plan after receiving the set of customer reactions.

20. The computer implemented system of claim 17, wherein the set of customer information and the set of customer advisor information includes a set of neuroeconomics attributes.
